(19) United States
(12) Patent Application Publication
(10) Pub. No.: US 2008/0008512 A1
(43) Pub. Date: Jan. 10, 2008

(54) Printhead Carrier for an Imaging Apparatus Having Cartridge Side Entry and Latching

(76) Inventors: Timothy John Hawryschuk, Lexington, KY (US); Randall Stoves, Auburn, AL (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/428,629

(22) Filed: Jul. 5, 2006

(51) Int. Cl. B41J 19/30

(52) U.S. Cl. 400/323

(57) ABSTRACT

An imaging apparatus includes a guide frame and a printhead carrier coupled to the guide frame for reciprocating movement along a main scan direction. The printhead carrier includes a cartridge receptacle forming a box-like structure defining an interior space. The receptacle has a carrier floor, a carrier back wall having a bearing member for engaging the guide frame, a carrier side wall, and a carrier side opening located opposite across from the carrier side wall. The printhead cartridge is received through the carrier side opening into the interior space during a cartridge loading operation. A door is coupled to the cartridge receptacle adjacent the carrier side opening. The door has an open position to facilitate insertion of the printhead cartridge through the carrier side opening into the interior space, and a latched position to facilitate containment of the printhead cartridge in the cartridge receptacle.

### FIELD OF THE INVENTION

The present invention relates to an imaging apparatus, and, more particularly, to a printhead carrier for an imaging apparatus having cartridge side entry and latching.

### BACKGROUND OF THE INVENTION

An imaging apparatus, such as an ink jet printer, forms an image on a print medium, such as paper, by applying ink to the print medium. Such an ink jet printer includes a reciprocating printhead carrier that transports one or more ink jet printhead cartridges across the print medium along a bi-directional scanning path defining a print zone of the printer. An ink jet printhead cartridge, for example, includes both an ink tank containing ink and an ink jet micro-fluid ejection device, i.e., ink jet printhead, for selectively ejecting the ink. Each ink jet printhead cartridge is mounted to the printhead carrier.

There is an increasing desire to reduce the size of printers by the printing industry. Accordingly, every component is under scrutiny for optimal performance with minimal size. It is typical for printers to have carrier latches that hold their respective printhead cartridges in place on the printhead carrier. However, such carrier latches may involve several moving parts that often complicate the process of latching. Also, such carrier latches are designed such that a lid swings upward to permit the printhead cartridge to be loaded from the top. Further, such prior carrier latches may be oversized, as well as inefficient from a usability perspective, and provide little or no mechanical advantage to the user during latching.

### SUMMARY OF THE INVENTION

The invention, in one form thereof, is directed to an imaging apparatus including a guide frame and a printhead carrier coupled to the guide frame for reciprocating movement along the main scan direction. The printhead carrier includes a cartridge receptable forming a box-like structure defining an interior space. The receptacle has a carrier floor, a carrier back wall having a bearing member for engaging the guide frame, a carrier side wall arranged substantially perpendicular to the carrier back wall, and a carrier side opening located opposite across the carrier floor from the carrier side wall. The printhead cartridge is received through the carrier side operation into the interior space during a cartridge loading operation. A door is coupled to the cartridge receptacle adjacent the carrier side opening. The door has an open position to facilitate insertion of the printhead cartridge through the carrier side opening into the interior space, and the door has a latched position to facilitate containment of the printhead cartridge in the cartridge receptacle.

The invention, in another form thereof, is directed to a method for loading a printhead cartridge into a printhead carrier having a cartridge receptacle defining an interior space for receiving the printhead cartridge. The method includes inserting the printhead cartridge through a side opening in the cartridge receptacle into the interior space along an arc-shaped loading path.

The invention, in another from thereof, is directed to a printhead carrier for mounting a printhead cartridge. A cartridge receptacle forms a box-like structure defining an interior space. The receptacle has a carrier floor, a carrier back wall, a carrier side wall arranged substantially perpendicular to the carrier back wall, and a carrier side opening located opposite across the carrier floor from the carrier side wall. The printhead cartridge is received through the carrier side opening into the interior space during a cartridge loading operation. A door is coupled to the cartridge receptacle adjacent the carrier side opening. The door has an open position to facilitate insertion of the printhead cartridge through the carrier said opening into the interior space, and a latched position to facilitate containment of the printhead cartridge in the cartridge receptacle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention;

FIG. 2 is a side view of a portion of the imaging apparatus shown in FIG. 1;

FIG. 3A is a bottom perspective view of a printhead cartridge and shows cartridge positioning datums;

FIG. 3B is another bottom perspective view of the printhead cartridge of FIG. 3A showing alternate cartridge positioning datums;

FIG. 4 is a side perspective view of a printhead carrier of the imaging apparatus of FIG. 2, with the side door in the open position;

FIG. 5A is a perspective view of the printhead carrier of FIG. 4, with the side door in the latched position;

FIG. 5B is a perspective view of the printhead carrier of FIG. 5A, at an intermediate stage of opening the side door;

FIG. 5C is a perspective view of the printhead carrier of FIG. 5A with the side door in the open position, exposing the installed printhead cartridge;

FIGS. 6A-6E are bottom views of the cartridge receptacle of the printhead carrier that illustrate the progressive loading stages of the side entry loading of the printhead cartridge of FIG. 5C into the cartridge receptacle of the printhead carrier along an arc-shaped loading path; and

FIG. 7 is a flowchart of a method for loading a printhead cartridge into a printhead carrier in accordance with an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DESCRIPTION OF THE PREFERRED EMBODIMENT

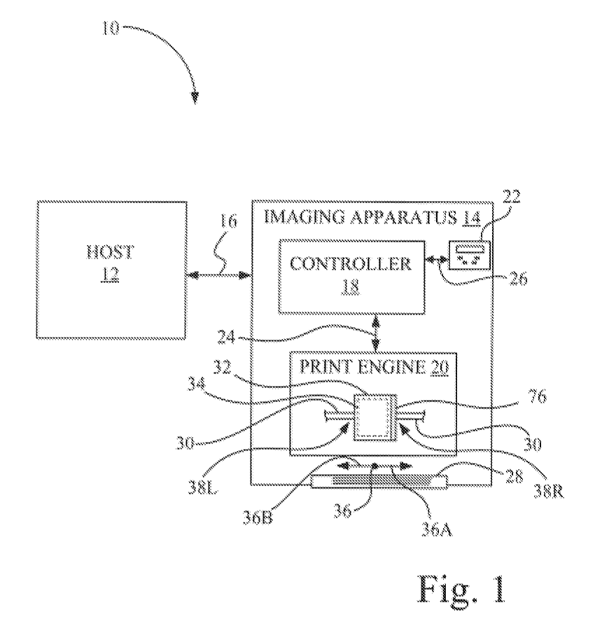

Referring to FIG. 1, there is shown a diagrammatic depiction of an imaging system 10 embodying the present invention. Imaging system 10 may include a host 12 and an imaging apparatus 14. Imaging apparatus 14 communicates with host 12 by way of a communications link 16. Communications link 16 may be established by a direct cable connection, wireless connection or by a network connection such as for example an Ethernet local area network (LAN). As used herein, the term “imaging apparatus” is a device that forms a printed image on a print medium.

Alternatively, imaging apparatus 14 may be a standalone unit that is not communicatively linked to a host, such as host 12. For example, imaging apparatus 14 may take the form of an all-in-one, i.e., multifunction, machine that includes standalaone copying and facsimile capabilities, in addition to optionally serving as a printer when attached to a host, such as host 12.

Host 12 may be, for example, a personal computer including an input/output (I/O) device, such as keyboard and display monitor. Host 12 further includes a processor, input/output (I/O) interfaces, memory, such as RAM, ROM, NVRAM, and a mass data storage device, such as a hard drive, CD-ROM and/or DVD units. During operation, host 12 may include in its memory a software program including program instructions that function as an imaging driver, e.g., printer driver software, for imaging apparatus 14. Alternatively, the imaging driver may be incorporated, in whole or in part, an imaging apparatus 14.

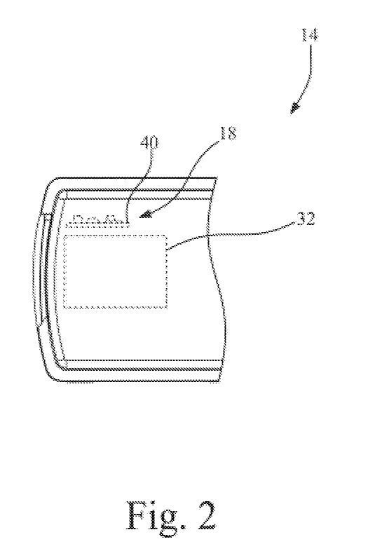

In the embodiment of FIG. 1, imaging apparatus 14 includes a controller 18, a print engine 20 and a user interface 22. FIG. 2 shows a side view of imaging apparatus 14, in the form of a compact ink jet printer.

Controller 18 includes a processor unit and associated memory, and may be formed as an Application Specific Integrated Circuit (ASIC). Controller 18 communicates with print engine 20 by way of a communications link 24. Controller 18 communicates with user interface 22 by way of a communications link 26. Communications links 24 and 26 may be established, for example, by using standard electrical cabling or bus structures, or by wireless connection.

Print engine 20 may be, for example, an ink jet print engine configured for forming an image on a sheet of print media 28, such as a sheet of paper, transparency or fabric. Print engine 20 may include, for example, a guide frame 30 and a reciprocating printhead carrier 32 slidably coupled to guide frame 30. Printhead 32 is mechanically and electrically configured to mount and carry at least one printhead cartridge 34.

Guide frame 30 defines a bi-directional main scan path 36, including direction 36A and direction 36B. During a printing operation, guide frame 30 guides printhead carrier 32 back and forth along bi-directional main scan path 36, and in turn printhead carrier 32 transports printhead cartridge 34 in a reciprocating manner over an image surface of the sheet of print media 28.

In accordance with the present invention, printhead carrier 32 is configured to facilitate side entry loading and side latching of printhead cartridge 34. In the embodiment shown in FIG. 1, for example, printhead cartridge 34 may be installed in printhead carrier 32 in direction 36B from side 38R (right side as shown in FIG. 1) of printhead carrier 32 to side 38L (left side as shown in FIG. 1) of printhead carrier 32 via a side door 76. Those skilled in the art will recognize that the principles of the present invention may be applied in the alternative such that side door 76 may be located on side 38L of printhead cartridge 34 such that printhead cartridge 34 may be installed in printhead carrier 32 in direction 36A from side 38L toward side 38R of printhead carrier 32.

Referring to FIG. 2, since imaging apparatus 14 is configured to facilitate side entry loading of printhead cartridge 34, electronic components, such as a printed circuit board 40 (shown in dashed lines) including controller 18, may be positioned at a location above printhead carrier 32, thereby contributing to a reduction of the footprint of imaging apparatus 14 when compared to top loading designs.

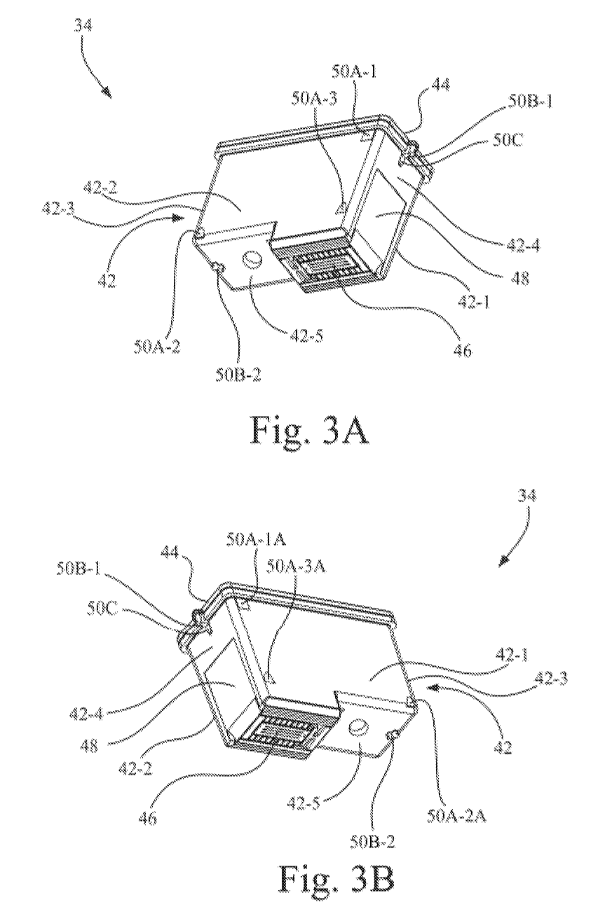

FIGS. 3A and 3B show a front view, and a bottom perspective view, respectively, of printhead cartridge 34. Printhead cartridge 34 includes a reservoir body 42, a top cover 44 and an ink jet printhead 46. Reservoir body 42 includes a first side 42-1, a second side 42-2, a front side 42-3, a back side 42-4, and a bottom side 42-5. Electrical connections are made to ink jet printhead 46 from controller 18 via a tape automated bond (TAB) circuit 48 located on back side 42-4 of printhead cartridge 34.

As shown in FIG. 3A, printhead cartridge 34 includes a plurality of positioning datums, individually identified as datums 50A-1, 50A-2, 50A-3, 50B-1, 50B-2, and 50C. Datums 50A-1, 50A-2, and 50A-3 are located on side 42-2. Datum 50B-1 is located on an upper lip just below top cover 44 at back side 42-4. Datum 50B-2 is located on bottom side 42-5 near front side 42-3. Datum 50C is located on an upper portion of back side 42-4 adjacent to datum 50B-1. Datums 50A-1, 50A-2, 50A-3, 50B-1, 50B-2, and 50C may, for example, be in the form of raised surfaces. As further shown in FIG. 3B, printhead cartridge 34 also includes a plurality of alternate positioning datums, individually identified as datums 50A-1A, 50A-2A, and 50A-3A located on side 42-1.

Ink is contained in reservoir body 42, and top cover 44 completes the enclosure to contain the ink. Fluid passageways (not shown) provide one or more paths for ink to flow from reservoir body 42 to ink jet printhead 46.

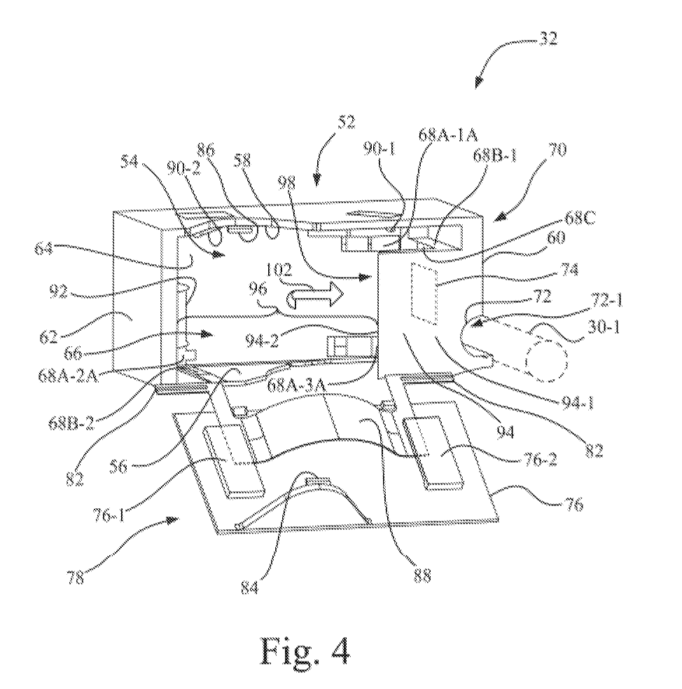

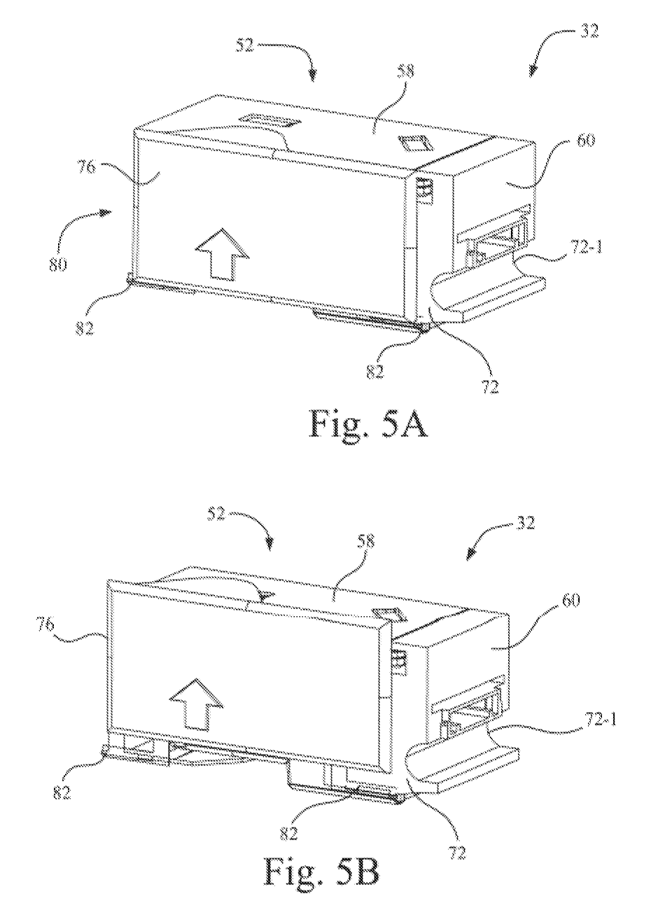

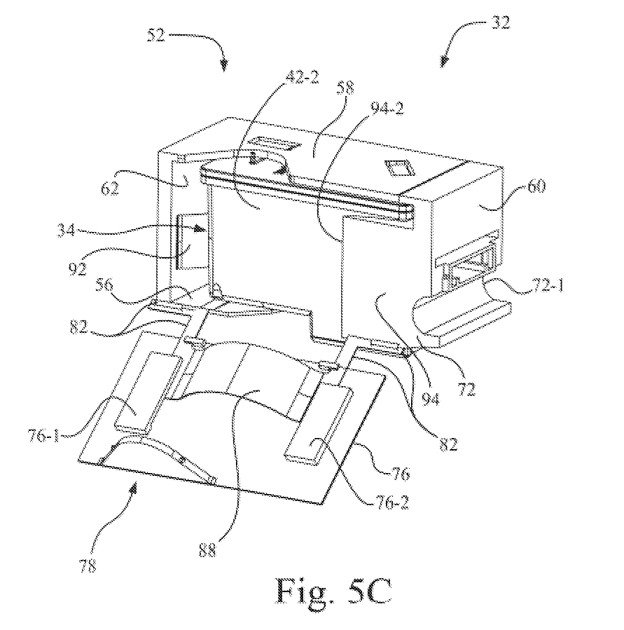

Referring now to FIGS. 4 and 5A-5C, printhead carrier 32 includes a cartridge receptacle 52 forming a box-like structure defining an interior space 54. Cartridge receptacle 52 has a carrier floor 56, a carrier ceiling 58, a carrier back wall 60, a carrier front wall 62, a carrier side wall 64 and a carrier side opening 66.

In one exemplary embodiment, cartridge receptacle 52 of printhead carrier 32 is molded as a single-piece unitary structure having defined therein positioning datums 68A-1A, 68A-2A, 68A-3A located on carrier side wall 64, positioning datums 68B-1 and 68C located on carrier back wall 60, and a positioning datum 68B-2 located on carrier floor 56. The datums of printhead carrier 32 define absolute locating positions for positioning printhead cartridge 34 in printhead carrier 32.

Carrier back wall 60 has an exterior 70 including a bearing member 72 that engages guide frame 30 by way of a slidable coupling. For example, guide frame 30 may include a guide rod 30-1, and bearing member 72 may have a bore 72-1 for receiving the guide rod of guide frame 30. A set of electrical contacts 74 are provided on carrier back wall 60 in interior space 54. The set of electrical contacts 74 are communicatively coupled to controller 18, such as by a multi-conductor cable. The step of electrical contacts 74 provide electrical power and signal communication to TAB circuit 48 when printhead cartridge 34 is installed in printhead carrier 32.

Each of the carrier back wall 60, carrier front wall 62, and carrier side wall 64 extends upwardly from a perimeter of carrier floor 56, with carrier side wall 64 being interposed between carrier back wall 60 and carrier front wall 62. Carrier front wall 62 is positioned opposite across carrier floor 56 from carrier back wall 60. Carrier side wall 64 is arranged substantially perpendicular to each of carrier back wall 60 and carrier front wall 62. Carrier ceiling 58 is positioned opposite carrier floor 56, and is separated therefrom by carrier back wall 60, carrier front wall 62, and carrier side wall 64. Carrier side opening 66 is located opposite across carrier floor 56 from carrier side wall 64, wherein printhead cartridge 34 is received through carrier side opening 66 into interior space 54 during a cartridge loading operation.

Door 76, sometimes referred to herein as a side door, is coupled to cartridge receptacle 52 adjacent carrier side opening 66. Door 76 has an open position 78 to facilitate said entry insertion of printhead cartridge 34 through carrier side operation 66 into interior pace 54. As shown in FIG. 5A, door 76 has a latched position 80, e.g., wherein door 76 engages cartridge receptacle 52 at carrier side opening 66, to facilitate containment of printhead cartridge 34 in cartridge receptacle 52. As shown in FIGS. 4 and 5C, a pair of slide/pivot members 82 couple door 76 to cartridge receptacle 52 to permit door 76 to both move linearly and rotate relative to cartridge receptacle 52. Door 76 inlcudes a pair of slide guides 76-1, 76-2 that are spaced apart along the width-wise extent of door 76 to slidably receive slide/pivot members 82 to facilitate the linear movement of door 76 relative to cartridg receptacle 52. In addition, door 76 has a tab 84 and cartridge receptacle 52 has a catch 86 for receiving tab 84 to form a latch. Latch 86 may be, for example, an opening into which tab 84 is releaseably received.

To open door 76, as shown in FIGS. 5B and 5C, door 76 is first slid upwardly to disengage tab 84 of door 76 from catch 86 of cartridge receptacle 52. Next, door 76 is rotated away from cartridge receptacle 52 to achieve the open position 78. Conversely, door 76 is latched by rotating door 76 toward cartridge receptacle 52, i.e., toward latched position 80, and then linearly sliding door 76 until tab 84 latches into catch 86, thereby achieving the latched position 80.

Referring again to FIGS. 4 and 5C, a spring member 88 is mounted to door 76 that holds the corresponding datum 50A-1A, 50A-2A, 50A-3A of printhead cartridge 34 against positioning datums 68A-1A, 68A-2A, 68A-3A on carrier side wall 64 when door 76 is in latched position 80. In one embodiment, spring member 88 may be formed integral with slide/pivot members 82 from a single piece of material. Spring members 90-1 and 90-2 are attached to, e.g., molded into, carrier ceiling 58, which hold the corresponding datums 50B-1 and 50B-2 of printhead cartridge 34 against positioning datum 68B-1 on carrier back wall 60 and against positioning datum 68B-2 on carrier floor 56, respectively. A spring member 92 is mounted near carrier front wall 62, and in one embodiment is attached to carrier front wall 62. Spring member 92 holds the corresponding datum 50C of printhead cartridge 34 against positioning datum 68C on carrier back wall 60. Each of spring members 88, 90-1, 90-2, and 92 may be, for example, a leaf spring, cantilever spring, etc.

Cartridge receptacle 52 has a lateral guide member 94 positioned opposite across carrier floor 56 from carrier side wall 64. Lateral guide member 94 extends upwardly from carrier floor 56, and in the present embodiment terminates before reaching carrier ceiling 58. Lateral guide member 94 has a proximal end 94-1 and a distal end 94-2. Proximal end 94-1 connects to carrier back wall 60, and distal end 94-2 extends toward carrier front wall 62 and forms a gap 96 between distal end 94-2 and a carrier front wall 62 at carrier side opening 66.

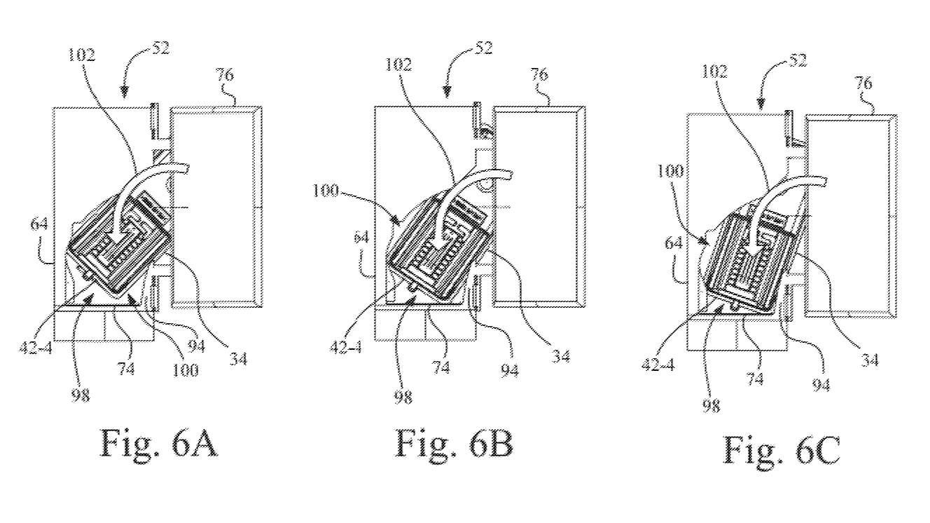

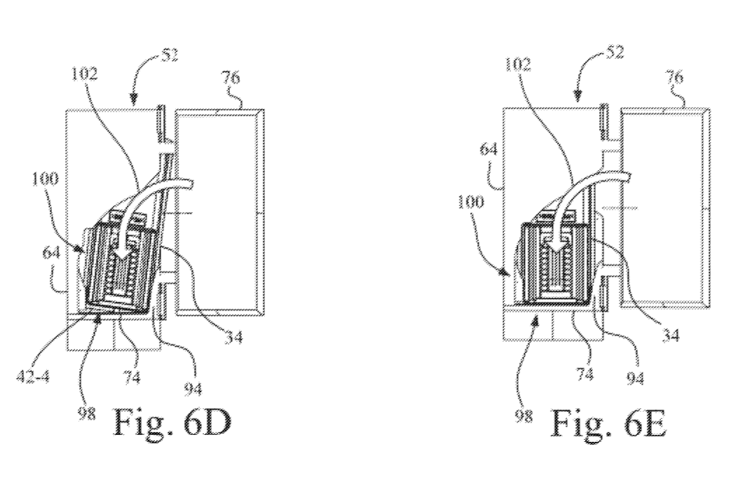

FIGS. 6A-6E are bottom views of cartridge receptacle 52 of printhead carrier 32 illustrating the progression of cartridge side entry insertion in accordance with the present invention. Lateral guide member 94 and carrier side wall 64 define a guide channel 98 for receiving a head portion 100 of printhead cartridge 34 (i.e., the portion of printhead cartridge 34 that includes ink jet printhead 46) and printhead cartridge 34 is rotated along an arc-shaped loading path 102 to the installed position shown in FIG. 6E. Thus, guide channel 98 is positioned to define arc-shaped loading path 102. For example, arc-shaped loading path 102 extends along a substantially horizontal plane beginning at a point outside cartridge receptacle 52, passes through carrier side opening 66 at gap 96 and around distal end 94-2 of internal guide member 94, and passes between lateral guide member 94 and carrier side wall 64 toward carrier back wall 60. By virtue of arc-shaped loading path 102, TAB circuit 48 of printhead cartridge 34 engages electrical contacts 74 on carrier back wall 60 head-on, with little or no sliding contact between them.

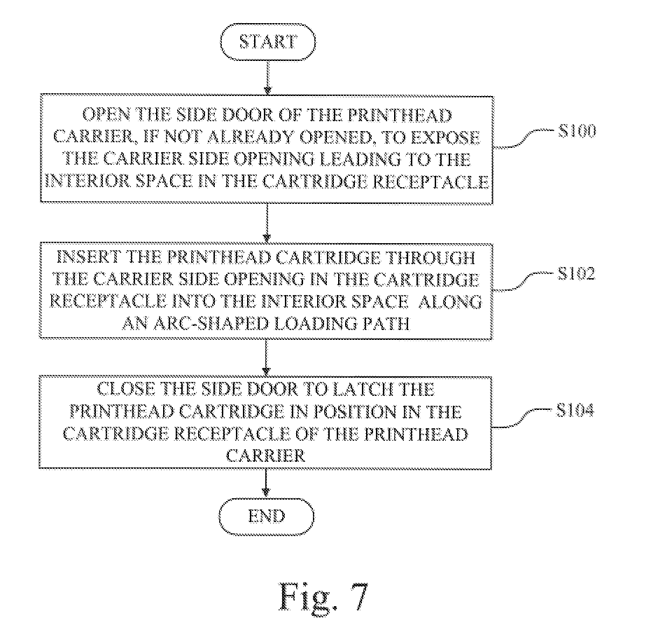

FIG. 7 is a flowchart of a method for the side entry loading of a printhead cartridge into a printhead carrier having a cartridge receptacle, in accordance with the embodiment describe above.

At step S100, side door 76 of printhead carrier 32 is opened, if not already opened, to expose carrier side opening 66 leading to interior space 54 in cartridge receptacle 52.

At step S102, printhead cartridge 34 is inserted through carrier side opening 66 in cartridge receptacle 52 into interior space 54 along arc-shaped loading path 102. At this time, head portion 100 of printhead cartridge 34 is received into guide channel 98 to guide a back side 42-4 of printhead cartridge 34 toward carrier back wall 60 of virtride receptacle 52 as printhead cartridge 34 is rotated along arc-shaped loading path 102.

At step S104, side door 76 is closed to latch printhead cartridge 34 in position in cartridge receptacle 52 of printhead carrier 32.

With the embodiments described above, the overall printhead carrier may be as much as 35 percent smaller than some prior designs. Also, user forces need to latch the printhead carrier have been reduced considerably, in some instances by as much as approximately 200 percent. Further, with the present invention the impulse forces applied to the printhead cartridge are reduced from that of many over-center snap-closure type latching designs, both during cartridge latching and de-latching.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An imaging apparatus, comprising:
a guide frame defining a main scan direction; and
a printhead carrier for mounting a printhead cartridge, said printhead carrier being coupled to said guide frame for reciprocating movement along said main scan directions, said printhead carrier including:
a cartridge receptacle forming a box-like structure defining an interior space, said receptacle having a carrier floor, a carrier back wall having a bearing member for engaging said guide frame, a carrier side wall arranged substantially perpendicular to said carrier wall, and a carrier side opening located opposite across said carrier floor from said carrier side wall, said printhead cartridge being received through said carrier side opening into said interior space during a cartridge loading operation; and
a door coupled to said cartridge receptacle adjacent said carrier side opening, said door having an open position to facilitate insertion of said printhead cartridge through said carrier side openings into said interior space, and said door having a latched position to facilitate containment of said printhead cartridge in said cartridge receptacle.

2. The imaging apparatus of claim 1, said cartridge receptacle having:
at least one positioning datum located on said carrier side wall in said interior space; and
a first spring member mounted to said door that holds said printhead cartridge against said at least one positioning datum on said carrier side wall when said door is in said latched position.

3. The imaging apparatus of claim 2, said cartridge receptacle having:
a carrier ceiling positioned opposite said carrier floor;
at least one positioning datum located on said carrier floor; and
a second spring member attached to said carrier ceiling that holds said printhead cartridge against said at least one positioning datum on said carrier floor.

4. The imaging apparatus of claim 3, said carrier back wall having formed thereon at least one positioning datum, said cartridge receptacle having:
a carrier front wall positioned opposite across said carrier floor from said carrier back wall; and
a third spring member mounted near said carrier front wall, wherein said third spring member holds said printhead cartridge against said at least one positioning datum on said carrier back wall.

5. The imaging apparatus of claim 1, wherein said cartridge receptacle is molded as a single-piece unitary structure having defined therein said at least one positiong datum located on said carrier side wall, at least one positiong datum located on said carrier floor, and at least one positioning datum located on side carrier back wall.

6. The imaging apparatus of claim 1, said cartridge receptacle having a lateral guide member positioned opposite across said carrier floor from said carrier side wall, said lateral guide member and said carrier side wall defining a guide channel for receiving a head portion of said printhead cartridge along an arc-shaped loading path being at a point outside said receptacle, passing through said carrier side opening and between said lateral guide member and said carrier side wall toward said carrier back wall.

7. The imaging apparatus of claim 1, said door having a tab and said cartridge receptacle having a catch for receiving said tab, wherein said door is latched by rotating said door to engage said carrier back wall, and then linearly sliding said door until said tab latches into said catch.

8. A method for loading a printhead cartridge into a printhead carrier having a cartridge receptacle defining an interior space for receiving said printhead cartridge, comprising inserting said printhead cartridge through a side opening in said cartridge receptacle into said interior space along an arc-shaped loading path.

9. The method of claim 8, wherein said arc-shaped loading path is defined by a guide channel, the method further comprising receiving a head portion of said printhead cartridge into said guide channel to guide a back side of said printhead cartridge toward a carrier back wall of said cartridge receptacle.

10. The method of claim 8, wherein prior to said inserting, said method comprising opening a side door of said printhead carrier to expose said side opening leading to said interior space in said cartridge receptacle.

11. The method of claim claim 10, wherein after said inserting, said method comprising closing said side door to latch said printhead cartridge in position in said cartridge receptacle of said printhead carrier.

12. A printhead carrier for mounting a printhead cartridge, comprising:
a cartridge receptacle forming a box-like structure defining an interior space, said receptacle having a carrier floor, a carrier back wall, a carrier side wall arranged substantially perpendicular to said carrier back wall, and a carrier side opening located opposite across said carrier floor from said carrier said wall, said printhead cartridge being received through said carrier side opening into said interior space during a cartridge loading operation; and
a door coupled to said cartridge receptacle adjacent said carrier side opening, said door having an open position to facilitate insertion of said printhead cartridge through said carrier side opening into said interior space, and said door having a latched position to facilitate containment of said printhead cartridge in said cartridge receptacle.

13. The printhead carrier of claim 12, comprising:
at least one positioning datum located in said carrier side wall in said interior space; and
a first spring member mounted to said door that holds said printhead cartridge against said at least one positioning datum on said carrier side wall when said door is in said latched position.

14. The printhead carrier of claim 13, comprising:
a carrier ceiling positioned opposite said carrier floor;
at least one positioning datum located on said carrier floor; and
a second spring member attached to said carrier ceiling that holds said printhead cartridge against said at least one positioning datum on said carrier floor.

15. The printhead carrier of claim 14, comprising:
at least one positiong datum formed on said carrier back wall;
a carrier front wall positioned opposite across said carrier floor from said carrier back wall; and
a third spring member mounted said carrier front wall, wherein said third spring member holds said printhead cartridge against said at least one positioning datum on said carrier back wall.

16. The printhead carrier of claim 12, wherein said cartridge receptacle is molded as a single-piece unitary structure having defined therein said at least one positioning datum located on said carrier side wall, at least one positioning datum located on said carrier floor, and at least one positioning datum located on said carrier back wall.

17. The printhead carrier of claim 12, said cartridge receptacle having a lateral guide member positioned opposite across said carrier floor from said carrier side wall, said lateral guide member and said carrier side wall defining a guide channel for receiving a head portion of said printhead cartridge along an arc-shaped loading path being at least a point outside said receptacle, passing through said carrier side opening, and between said lateral guide member and said carrier side wall toward said carrier back wall.

18. The printhead carrier of claim 12, said door having a tab and said cartridge receptacle having a catch for receiving said tab, wherein said door is latched by rotating said door to engage said carrier back wall, and then linearly sliding said door until said tab latches into said catch.
